(19) United States
(12) Patent Application Publication
(10) Pub. No.: US 2004/0018066 A1
(43) Pub. Date: Jan. 29, 2004

(54) Materials processing machine

(76) Inventor: Ekkehart Illigner, Augsburg (DE)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/422,072

(22) Filed: Apr. 23, 2003

(30) Foreign Application Priority Data
Apr. 27, 2002 (DE) 102 18 994.3

(51) Int. Cl. B23F 1/00

(52) U.S. Cl. 409/1

(57) ABSTRACT

A materials processing machine, in particular, a mill, a sifter or a rotary-vane feeder, having at least one articulated connection for movably holding at least one movable machine part on a stationary machine part. In order to achieve a simplified operation, in particular, when the machine is arranged in an isolator, the articulated connection contains a first pivoting arm that is movably coupled to the stationary machine part and at least one additional pivoting arm that is coupled in a pivoting fashion to the first pivoting arm and serves for holding the movable machine part.

### BACKGROUND OF THE INVENTION

1. Field of the Invention

The present invention relates to a materials processing machine, in particular, a mill, a sifter or a rotary-vane feeder, with at least one articulated connection for movably holding at least one movable machine part on a stationary machine part in order to achieve a simplified operation, in particular, when the machine is arranged in an isolator.

2. Prior Art

Materials processing machines, e.g., mills, sifters, rotary-vane feeders, cyclones, etc., are frequently shielded relative to the surroundings and accommodated in so-called isolators in order to perform work under sterile conditions. Such isolators usually consist of tightly sealed housings or receptacles, in which windows and, if applicable, doors or sluices are arranged. In order to handle or operate the machines arranged in the isolators, the housing or receptacle is frequently realized in the form of a glove box. In this case, special openings in the housing wall are sealed with gloves in such a way that the operator is able to insert his hands into the gloves from the outside and operate the machine arranged in the interior. However, the rigidly installed gloves significantly limit the freedom of motion and the ability to take hold of parts. This may result in problems, in particular, when handling heavy and bulky machine parts or when installing and removing parts to be exchanged. Machine parts that need to be frequently operated or removed, e.g., housing covers, mill doors and the like, are frequently coupled to a stationary machine part in a pivoting fashion with the aid of a conventional hinge joint such that they can, if required, be pivoted sideward. However, conventional hinge connections do not provide the freedom of motion, for example, needed for handling machine parts that need be placed onto a shaft and, if required, removed therefrom.

### SUMMARY OF THE INVENTION

The invention is based on the objective of developing a materials processing machine of the initially described type, which can be operated more easily, in particular, when it is arranged in an isolator.

More particularly, the present invention provides a materials processing machine, in particular, a mill, a sifter or a rotary-vane feeder, with at least one articulated connection for movably holding at least one movable machine part on a stationary machine part wherein the articulated connection contains a first pivoting arm that is movably coupled to the stationary machine part and at least one other pivoting arm that is coupled in a pivoting fashion to the first pivoting arm and serves for holding the movable machine part. Also, the materials processing machine according to the above may include a second pivoting arm coupled to the first pivoting arm is provided for carrying the movable machine part.

The materials processing machine according to can be arranged so that the first pivoting arm and the at least one other pivoting arm are connected to one another in an articulated fashion by means of a hinge bolt, or alternatively connected to one another by means of interlocking webs. If webs are employed, the interlocking webs are spaced apart from one another and connected to one another by means of a hinge bolt that is realized in the form of an adjusting bolt.

The materials processing machine according to the above can be constructed with the first pivoting arm arranged on the stationary machine part such that it can be pivoted about a hinge bolt. Also, the first pivoting arm can be coupled in a pivoting fashion to a separate hinge part.

The materials processing machine may be provided with a clamping device arranged on the stationary machine part for fixing the movable machine part on the stationary machine part. The clamping device can contain two clamping elements that can be pivoted sideward and tensioned by means of a clamping screw. Also, the pivoting range of the clamping elements about respective hinge pins can be limited by lateral limit stops.

The materials processing machine according to the foregoing can be provided with a first articulated connection for holding a housing part and a second articulated connection for holding an installation and removal device. Also, the housing part can be arranged on the at least one other pivoting arm of the first articulated connection such that it can be turned about a bearing journal. Further, the installation and removal device can contain a vertical support that is arranged on the at least one additional pivoting arm of the second articulated connection such that it can be turned about a bearing journal, and the height of the support can be adjustable.

The materials processing machine as characterized above can be provided with a mounting bushing arranged on the support for holding and for removing and installing a removable machine part.

The objective of the present invention is attained with a materials processing machine with the characteristics as set forth above. Practical embodiments and advantageous additional developments of the invention are defined above and will become more evident from the detailed description that follows.

One important advantage of the invention can be seen in the fact that the machine parts are also held and supported in the detached state such that their handling is simplified. The machine parts that are movably held with the aid of multi-jointed hinge connections can also be handled with a greater freedom of motion. For example, detachable machine parts cannot only be pivoted sideward, but also displaced in the direction of their longitudinal axis or transverse thereto. This makes it possible to easily and rapidly manipulate the machine, namely also within an isolator housing. The machine contains, in particular, no small parts that are difficult to take hold of and may fall on the floor.

### BRIEF DESCRIPTION OF THE DRAWINGS

Other characteristics and advantages of the invention will be apparent from the discussion of the following detailed description of preferred embodiments that are illustrated in the appended figures, which show:

FIG. 1 shows a partial representation of a mill in the closed state according to the invention;

FIG. 2 shows the mill according to FIG. 1 with the mill cover in the open position;

FIG. 3 shows the mill according to FIG. 1 with the mill cover in the open position and with the hammer wheel removed, and

FIG. 4 shows a sectional representation of a hinge connection.

### DETAILED DESCRIPTION OF PREFERRED EMBODIMENTS

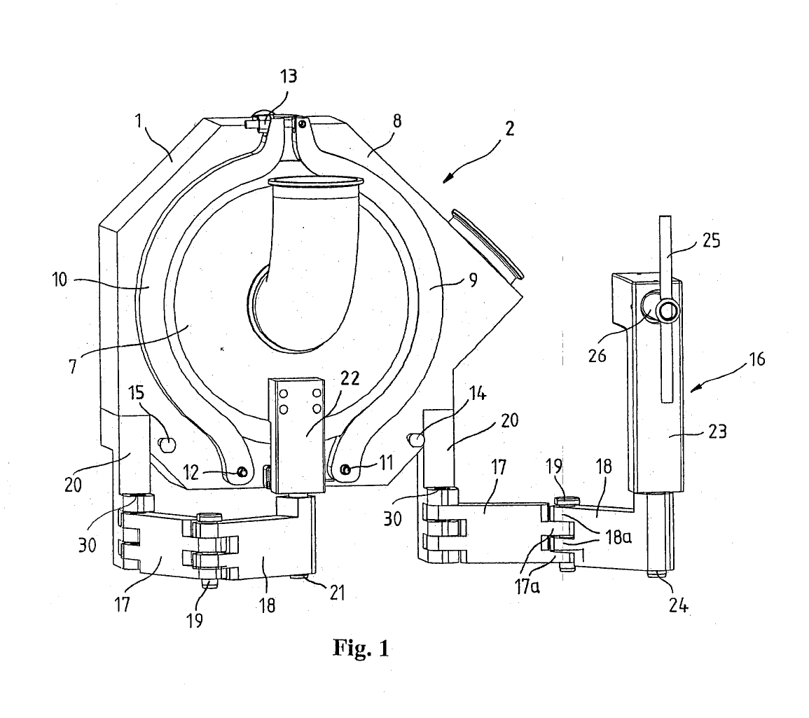

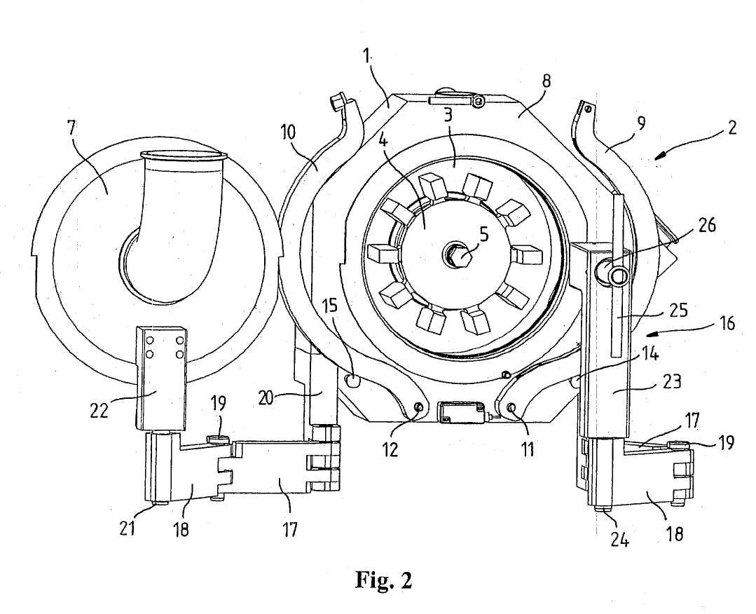

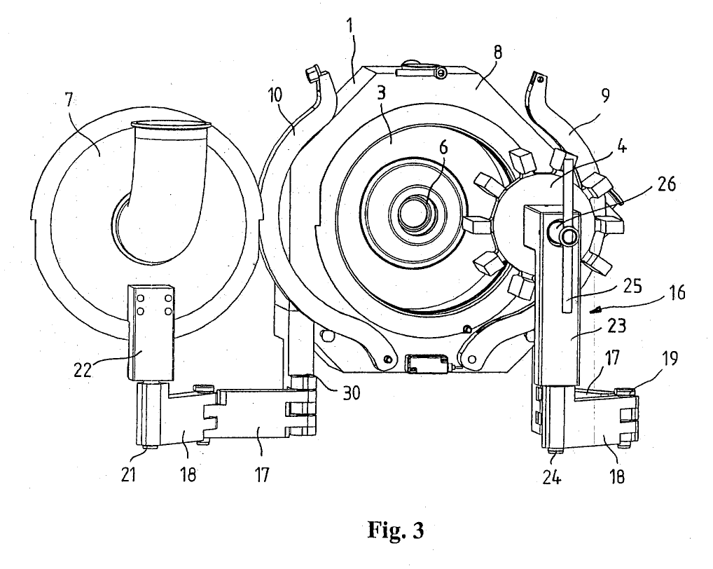

Referring now to the drawings, FIGS. 1-3 show, in only partial illustration, a stationary machine housing 1 of a known mill 2. This mill 2 is intended for being arranged in a not-shown isolator housing in a manner known in the art. According to FIG. 2, the machine housing 1 contains a circular opening 3, in which a motor-driven hammer wheel 4 is arranged. The hammer wheel 4 is removably mounted on the drive shaft 6 shown in FIG. 3 by means of a central mounting screw 5. The mounting screw 5 preferably is held on the hammer wheel in a captive fashion. The opening 3 is closed with a housing cover 7 that is held on the machine housing 1 such that it can be pivoted sideward with the aid of a multi-jointed hinge connection described in greater detail below. A ring (not-shown) is arranged on the rear side of the housing cover 7 and protrudes into the opening 3 when the housing cover is closed. A grinding track is formed on the inner side of this ring. In order to fix the housing cover 7 on the machine housing in its closed position, two laterally pivoted semicircular clamping elements 9 and 10 are coupled to the front face 8 of the machine housing 1. On their lower end, the clamping elements 9 and 10 are arranged underneath the opening 3 such that they can be respectively pivoted about hinge pins 11 and 12, wherein their upper end can be tensioned by means of a clamping screw 13 or the like. The inner side of both clamping elements 9 and 10 contains a groove, into which the edge of the housing cover 7 engages. Corresponding limit stops 14 and 15 are mounted on the front face 8 in order to limit the lateral pivoting movement of both clamping elements 9 and 10.

Two articulated connections that are realized in the form of multi-jointed hinge connections are arranged on the machine housing 1, wherein one connection serves for holding the housing cover 7 and the other connection serves for holding a device 16 that serves for installing and removing the hammer wheel 4 and is described in greater detail below. Both hinge connections respectively consist of a first pivoting arm 17 that is coupled in a pivoting fashion to the machine housing 1 and a second pivoting arm 18 that is coupled in a pivoting fashion to the first pivoting arm, wherein said pivoting arms respectively carry the housing cover 7 and the device 16. The two pivoting arms 17 and 18 are connected by means of interlocking webs 17a and 18a and a hinge bolt 19, namely such that they can be pivoted about the central axis of said hinge bolt. In the embodiment shown, the two pivoting arms 17 are coupled to the machine housing 1 by means of special hinge elements 20, on which the pivoting arms 17 are arranged such that they can be pivoted about a hinge bolt 30. The hinge elements 20 are screwed to the machine housing 1 or otherwise connected thereto. The hinge elements 20 may also be realized integrally with the machine housing 1.

In the left hinge connection according to FIGS. 1-3, which serves for movably holding the housing cover 7, a downwardly protruding vertical bearing journal 21 is rotatably supported on the free end of the second pivoting arm 18 in a holding plate 22 that is rigidly connected to the housing cover 7. Due to this measure, the housing cover 7 not only can be pivoted forward with the aid of the hinge connection, but also turned by 360 degrees, if so required.

The right hinge connection in FIGS. 1-3 serves for holding the device 16 for installing and removing the hammer wheel 4 on/from the machine housing 1. The device 16 contains an angled support 23 that is also arranged on the free end of the second pivoting arm 18 such that it can be turned about a vertical bearing journal 24. A mounting bushing 26 is arranged in the upper portion of the support 23 such that it can be turned by means of a handle 25, wherein the mounting bushing serves for actuating the mounting screw 5 that is held on the hammer wheel 4 in a captive fashion and for removing or reinstalling the hammer wheel 4 from/on the drive shaft 6. The support 23 is arranged on the pivoting arm 18 in a vertically displaceable fashion so as to allow a vertical alignment of the mounting bushing 26 relative to the mounting screw 5.

In the previously described mill 2, the housing cover 7 can be opened in a relatively simple and rapid fashion. It is merely required to loosen the clamping screws held on the clamping element 9 in order to remove the housing cover 7 from the machine housing 1 by laterally pivoting away both clamping elements 9 and 10. The housing cover 7 is held by means of a multi-jointed hinge connection such that the inner ring with the grinding track formed thereon is initially pulled out of the opening 3 and can then be pivoted sideward. Subsequently, the hammer wheel 4 is loosened with the aid of the installation device 16 and also removed from the opening 3. Small parts that are difficult to take hold of and may fall on the floor are eliminated. Due to these measures, a mill of this type can also be easily operated in a glove box with limited access.

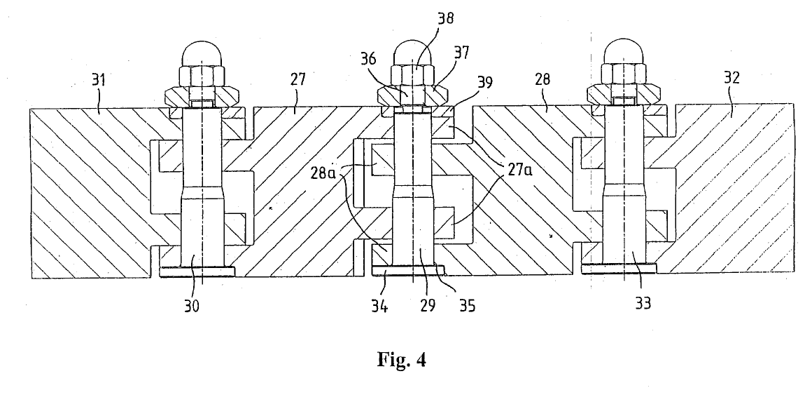

FIG. 4 shows another embodiment of a double-jointed hinge connection for holding a movable machine part on a stationary machine part. In this articulated connection, a first pivoting arm 27 and a second pivoting arm 28 are connected in an articulated fashion by means of a first hinge bolt 29 that is realized in the form of an adjusting bolt. The first pivoting arm 27 is coupled to a stationary hinge part 31, e.g., a machine housing or a stationary wall, such that it can be pivoted about a second hinge bolt 30. A movable machine part 32, e.g., a housing cover, is coupled to the right end of the second pivoting arm 28 in FIG. 4 such that it can be pivoted about a third hinge bolt 33. The two pivoting arms 27 and 28 contain interlocking webs 27a and 28a that are connected to one another by means of a hinge bolt 29. In the embodiment shown, the lower end of the hinge bolt 29 is provided with a head 34 that lies in a corresponding depression 35 in the lower web 28a of the second pivoting arm 28. On its upper end, the hinge bolt 29 contains a threaded pin 36, onto which an adjusting nut 37 and a locking nut 38 in the form of a cap nut are screwed. A washer 39 is arranged between the upper web 27a of the pivoting arm 27 and the adjusting nut 37.

According to FIG. 4, the webs 27a and 28a of the two pivoting arms 27 and 28 are spaced apart from one another by a predetermined distance. This makes it possible to adjust the elevation of the pivoting arm 28 by turning the adjusting nut 37 after the locking nut 38 has been loosened.

The invention is not limited to the described embodiment that is illustrated in the figures. For example, the articulated connection may, if so required with respect to the mobility, comprise more than two pivoting arms that are connected to one another in an articulated fashion. The invention can be utilized in all instances in which machine parts that are not easily accessible need to moved and handled.

What is claimed is:

1. Materials processing machine, in particular, a mill, a sifter or a rotary-vane feeder, with at least one articulated connection for movably holding at least one movable machine part on a stationary machine part wherein the articulated connection contains a first pivoting arm that is movably coupled to the stationary machine part and at least one other pivoting arm that is coupled in a pivoting fashion to the first pivoting arm and serves for holding the movable machine part.

2. Materials processing machine according to claim 1, wherein a second pivoting arm coupled to the first pivoting arm is provided for carrying the movable machine part.

3. Materials processing machine according to claim 1, wherein the first pivoting arm and the at least one other pivoting arm are connected to one another in an articulated fashion by means of a hinge bolt.

4. Materials processing machine according to claim 1, wherein the first pivoting arm and the at least one other pivoting arm are connected to one another by means of interlocking webs.

5. Materials processing machine according to claim 4, wherein the interlocking webs are spaced apart from one another and connected to one another by means of a hinge bolt that is realized in the form of an adjusting bolt.

6. Materials processing machine according to claim 1, wherein the first pivoting arm is arranged on the stationary machine part such that it can be pivoted about a hinge bolt.

7. Materials processing machine according to claim 1, wherein the first pivoting arm is coupled in a pivoting fashion to a separate hinge part.

8. Materials processing machine according to claim 1, wherein a clamping device for fixing the movable machine part on the stationary machine part is arranged on the stationary machine part.

9. Materials processing machine according to claim 8, wherein the clamping device contains two clamping elements that can be pivoted sideward and tensioned by means of a clamping screw.

10. Materials processing machine according to claim 9, wherein the pivoting range of the clamping elements about respective hinge pins is limited by lateral limit stops.

11. Materials processing machine according to claim 1, wherein there is provided a first articulated connection for holding a housing part and a second articulated connection for holding an installation and removal device.

12. Materials processing machine according to claim 11, wherein the housing part is arranged on the at least one other pivoting arm of the first articulated connection such that it can be turned about a bearing journal.

13. Materials processing machine according to claim 11, wherein the installation and removal device contains a vertical support that is arranged on the at least one additional pivoting arm of the second articulated connection such that it can be turned about a bearing journal.

14. Materials processing machine according to claim 13, wherein the height of the support is adjustable.

15. Materials processing machine according to claim 13, wherein a mounting bushing is arranged on the support for holding and for removing and installing a removable machine part.
